(19) United States
(12) Patent Application Publication
(10) Pub. No.: US 2025/0130529 A1
(43) Pub. Date: Apr. 24, 2025

(54) HOROLOGICAL MOVEMENT COMPRISING A MECHANISM FOR ADJUSTING THE POSITION OF DISPLAYS

(71) Applicant: ETA SA Manufacture Horlogère Suisse, Grenchen (CH)

(72) Inventor: Stefan ROMBACH, Bienne (CH)

(73) Assignee: ETA SA Manufacture Horlogère Suisse, Grenchen (CH)

(21) Appl. No.: 18/915,437

(22) Filed: Oct. 15, 2024

(30) Foreign Application Priority Data
Oct. 24, 2023 (EP) 23205573.1

(51) Int. Cl. G04B 19/253; G04B 19/24

(52) U.S. Cl. CPC G04B 19/253; G04B 19/241

(57) ABSTRACT

A horological movement including a driving wheel set kinematically linked to a first and to a second display mechanism respectively intended to drive a first and a second display of a time value, a mechanism for adjusting the position of these displays including a sliding-gear assembly and a control member adapted to assume an adjusting position in which it is engaged with the sliding-gear assembly and in which when urged in a first direction of rotation, it drives the sliding-gear assembly into a first correction position in which the sliding-gear assembly is able to cooperate with the first display mechanism so as to modify the position of the first display, and when urged in a second direction of rotation, it drives the sliding-gear assembly into a second correction position in which the sliding-gear assembly is able to cooperate with the second display mechanism so as to modify the position of the second display.

### TECHNICAL FIELD OF THE INVENTION

The invention relates to the field of watchmaking and in particular to a horological movement comprising a mechanism for adjusting the position of displays.

### TECHNOLOGICAL BACKGROUND

The mechanisms for correcting a function of a horological movement of a watch allow a user, by operating a control member of the watch, to modify the position of one of its displays, for example the current time.

When the horological movement includes a plurality of functions, for example a date, a second time zone, etc., their respective correction is typically carried out using the winding stem. In particular, prior art documents describe the positioning of the winding stem in a particular axial position in order to select the function to be corrected, and to pivot said stem in order to correct the selected function.

Beyond a certain number of functions, it can be particularly tricky to position the winding stem axially. More specifically, it is understood that finding the desired position becomes tedious with more than three distinct available axial positions.

Moreover, when it has a plurality of functions, the correction mechanism is relatively complex to implement since, in each of its axial positions, the winding stem must be kinematically connected to specific components of the horological movement in order to be able to act on a given function. Moreover, adding specific functions to a horological movement increases its dimensions, since each function typically has its own drive mechanism.

### SUMMARY OF THE INVENTION

The present invention aims to overcome these drawbacks by offering a horological movement provided with a plurality of functions that can be easily and quickly corrected.

Another aim of the present invention is to simplify the movement in order to minimise its dimensions.

To this end, the invention relates to a horological movement comprising a driving wheel set kinematically linked to a first and to a second display mechanism respectively intended to drive a first and a second display of a time value, a mechanism for adjusting the position of these displays including a sliding-gear assembly and a control member adapted to assume an adjusting position in which it is engaged with the sliding-gear assembly and in which:
when urged in a first direction of rotation, it drives the sliding-gear assembly into a first correction position in which the sliding-gear assembly is able to cooperate with the first display mechanism so as to modify the position of the first display, and
when urged in a second direction of rotation, it drives the sliding-gear assembly into a second correction position in which the sliding-gear assembly is able to cooperate with the second display mechanism so as to modify the position of the second display.

The first display mechanism includes a click mechanism having a click wheel capable of kinematically linking the driving wheel set and a display wheel carrying the first display so as to transmit the rotation of the driving wheel set to the first display, said click wheel being movable in a plane orthogonal to its axis of rotation when the control member is operated to modify the position of the first display, so as to interrupt the kinematic link between the first display mechanism and the driving wheel set.

It is thus simple for the user to correct a function of the horological movement by pivoting in one direction or another.

Moreover, thanks to the click mechanism, the number of components in the horological movement is kept to a minimum.

In particular embodiments, the invention can further include one or more of the following features, which must be considered singly or according to any combination technically possible.

In particular embodiments, the driving wheel set includes a driving wheel which lies in the same plane as the click wheel and the display wheel.

In particular embodiments, the click mechanism comprises a return member integral with the click wheel so as to force it towards a stop position in which it is engaged with the driving wheel and with the display wheel.

In particular embodiments, the return member is arranged in the same plane as the driving wheel, the click wheel and the display wheel.

In particular embodiments, when in the first position, the sliding-gear assembly is engaged with the first display mechanism and disengaged from the second display mechanism, and when in the second position, the sliding-gear assembly is engaged with the second display mechanism and disengaged from the first display mechanism.

In particular embodiments, the sliding-gear assembly includes, arranged coaxially:
a driving wheel by means of which it can be rotated by the control member,
a first adjusting wheel kinematically connected to the first display mechanism when the control member is in the adjusting position and is urged in the first direction of rotation, and
a second adjusting wheel kinematically connected to the second display mechanism when the control member is in the adjusting position and is urged in the second direction of rotation.

In particular embodiments, the display wheel is formed by a time zone wheel, the first display mechanism comprising a transmission wheel kinematically connecting the time zone wheel and the first adjusting wheel when the control member is in the adjusting position and is urged in the first direction of rotation. The position of the first display is thus changed continuously when the control member is urged in the first direction of rotation.

In particular embodiments, the second wheel of the sliding-gear assembly is formed by a cam including at least one corrector finger-piece able to cooperate with a toothing of the second display mechanism integral with the second display so as to drive said second display in sequential rotation during the rotation of said sliding-gear assembly when it occupies the second correction position and when the control member is urged in the second direction of rotation.

In particular embodiments, the driving wheel set comprises a driving finger-piece able to cooperate with the toothing of the second display mechanism to drive the second display in sequential rotation during the rotation of said driving wheel set.

In particular embodiments, the click mechanism includes a guide structure adapted to movably guide the click wheel when the sliding-gear assembly is urged in the first direction of rotation.

In particular embodiments, the guide structure is configured to guide the click wheel rotatably about an axis passing through the centre of the driving wheel set or translatably along a rectilinear trajectory tangential to a circle concentric with the driving wheel set, when the sliding-gear assembly is urged in the first direction of rotation.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a perspective, top view of part of a horological movement comprising a mechanism for adjusting the position of displays of a time value, according to a preferred example embodiment of the invention;

FIG. 2 shows a perspective, bottom view of the movement shown in FIG. 1;

FIG. 3 shows a perspective view of the movement shown in FIG. 1, in which the position of a first display is modified;

FIG. 4 shows a perspective view of the movement shown in FIG. 1, in which the position of a second display is modified.

It should be noted that the figures are not necessarily drawn to scale for clarity purposes.

### DETAILED DESCRIPTION OF THE INVENTION

The invention relates to a horological movement 10 intended to be housed in a watch case, and configured to drive two displays 20 and 30 of time values in addition to a display of the current time.

In the preferred example embodiment of the present invention, of these two time value displays 20 and 30, a first is a display of the time in an additional time zone different to that of the current time, and a second is a date display.

For reasons of clarity, the components of the horological movement known to a person skilled in the art are not described in this text and do not appear in the figures.

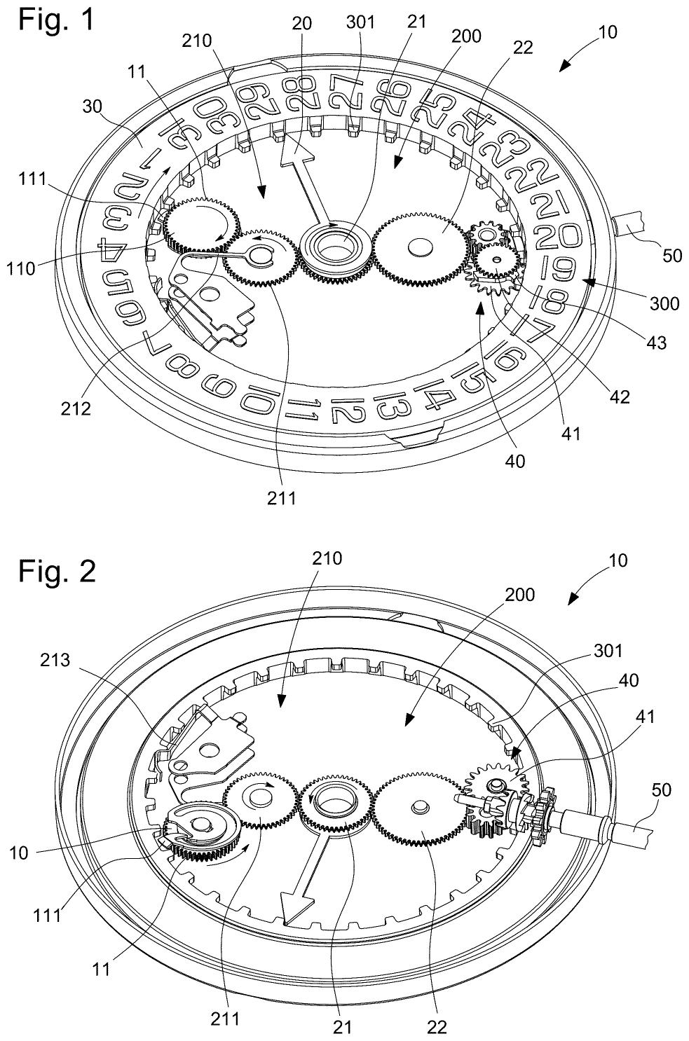

FIGS. 1 and 2 show the present invention during normal operation of the horological movement 10, i.e. when displaying the current time, the time in an additional time zone and the date. In particular, FIG. 1 shows the horological movement 10 seen from above and FIG. 2 shows the horological movement 10 seen from below.

The horological movement 10 comprises a driving wheel set 11 kinematically linked to a motion-work train in order to drive the first and second time value displays 20 and 30. In the preferred embodiment of the invention, the driving wheel set 11 is driven at one revolution per day by an hour wheel of the motion-work train (not shown in the figures).

Advantageously, the horological movement 10 includes a mechanism for adjusting the position of these displays 20 and 30, comprising a sliding-gear assembly 40 and a control member 50 intended to assume an adjusting position in which it is engaged with the sliding-gear assembly 40 and is capable of driving displacing both the first and second displays 20 and 30 in response to a user operating the watch.

Preferably, the control member 50 is formed by a winding stem linked to a winding button and the adjusting position is materialised by a predetermined axial position. The winding stem is configured to be kinematically linked to the sliding-gear assembly 40 by means of a system of intermediate wheels known to a person skilled in the art, when the control member 50 occupies the adjusting position. Such a system of intermediate wheels is shown in the figures but is not described in detail in the text because it is well known to a person skilled in the art.

As can be seen from the figures, the sliding-gear assembly 40 includes a driving wheel 41 by means of which it can be rotated by the control member 50 via the system of intermediate wheels.

The sliding-gear assembly 40 is engaged in a guide track so that it is free to rotate and move translatably in a direction orthogonal to the direction in which it is free to pivot. Thus, the sliding-gear assembly 40 is able to occupy two extreme positions in said guide track. The guide track is not shown in the figures for reasons of clarity and is formed, for example, by a through-groove made in a support structure for the horological movement 10, such as a bridge or a plate. The sliding-gear assembly 40 is driven into either one of these extreme positions by the control member 50 when it occupies the adjusting position, depending on the direction of rotation in which the control member is urged. These extreme positions are referred to as “correction positions” in the remainder of the text.

In particular, when it is positioned in the adjusting position by a user and is urged in a first direction of rotation, the control member 50 is configured to drive the sliding-gear assembly 40 into a first correction position in which the latter is able to cooperate with the first display mechanism 200 so as to modify the position of the first display 20.

As can be seen from the figures, the first display mechanism 200 includes a click mechanism 210 configured to allow the driving wheel set 11 to be kinematically linked to said first display mechanism 200 when the control member 50 is not operated, and to interrupt this kinematic linkage when the control member 50 is operated.

More specifically, the click mechanism 210 is equipped with a click wheel 211 capable of kinematically linking the driving wheel set 11 and a display wheel 21 carrying the first display 20 so as to transmit the rotation of the driving wheel set 11 to the first display 20, as illustrated by the arrows in FIG. 1. Moreover, the click wheel 211 can be moved translatably in a plane orthogonal to its axis of rotation or rotatably about the axis of the driving wheel set 11, when the control member 50 is urged in the first direction of rotation when it is in the adjusting position, so as to interrupt the kinematic link between the first display mechanism 200 and the driving wheel set 11. This feature prevents damage to the horological movement 10 by transmitting forces to the gear train and to the oscillator.

In the preferred example embodiment of the invention, the click mechanism 210 is provided with a click wheel 211 meshing with a driving wheel 110 of the driving wheel set 11 and with the display wheel 21. The driving wheel 110, the click wheel 211 and the display wheel 21 lie in the same plane, as can be seen in the figures, so as to minimise the thickness of the horological movement 10, while reducing the number of components in the horological movement.

Advantageously, the click mechanism 210 can comprise a return member 212 integral with the click wheel 211 so as to force it towards a stop position in which it is engaged with the driving wheel 110 and with the display wheel 21. In the example embodiment shown in the figures, the return member 212 is configured to hold the click wheel 211 in the axial position and is arranged so as to apply a return force to an arbor of the click wheel 211. Alternatively, the return member 212 can be arranged such that it bears against the toothing of the click wheel 211 to further minimise the thickness of the movement. The return member 212 is thus located in the same plane as the driving wheel 110, the click wheel 211 and the display wheel 21.

To summarise, the click wheel 211 is adapted to transmit motion from the driving wheel 110 to the display wheel 21 and to prevent transmission of motion from the display wheel 21 to the driving wheel 110. The operation of the click mechanism 210 is described in detail below.

In the preferred example embodiment of the invention, the display wheel 21 is formed by a time zone wheel. The first display mechanism 200 includes a transmission wheel 22 kinematically connecting the display wheel 21 and the sliding-gear assembly 40 when the control member 50 is in the adjusting position and is urged in the first direction of rotation.

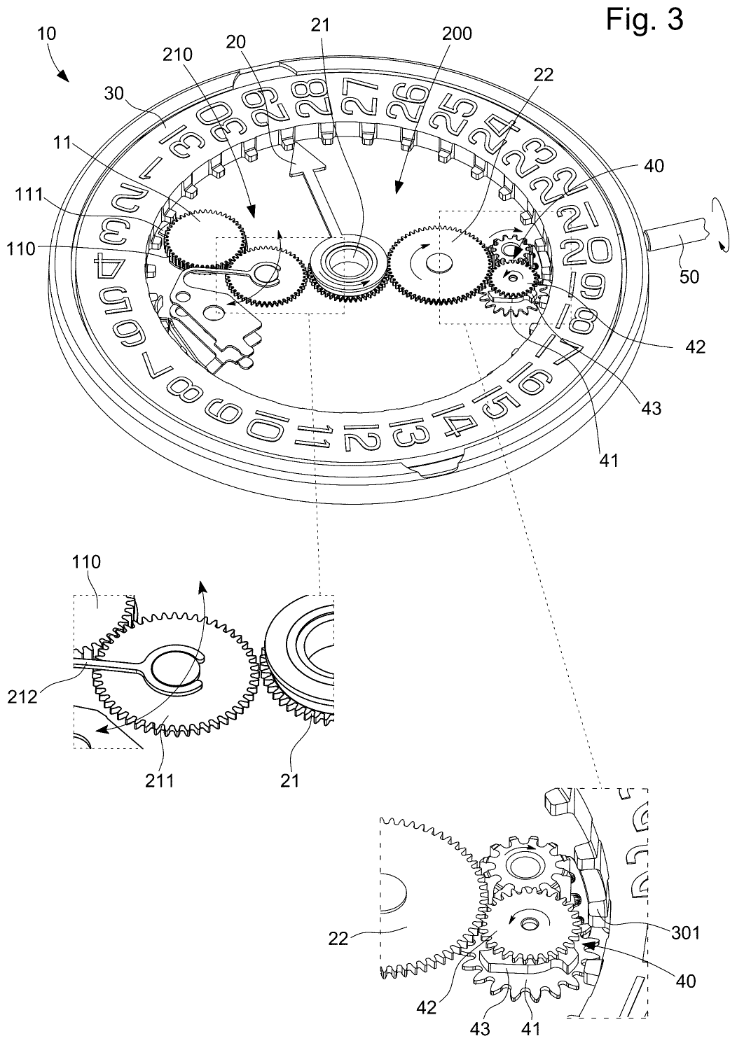

More specifically, as can be seen in the detail view on the right in FIG. 3, the sliding-gear assembly 40 includes a first adjusting wheel 42 kinematically connected to the transmission wheel 22 when the control member 50 is in the adjusting position and is urged in the first direction of rotation. The transmission wheel 22 thus drives the display wheel 21 rotatably, which moves the time display of an additional time zone. The detail view on the left in FIG. 3 shows that, during this rotation, the display wheel 21 causes the click wheel 211 to roll around the driving wheel 110 and disengage from the display wheel 21. In particular, when the display wheel 21 rotates, the toothing thereof exerts a torque on the toothing of the click wheel 211, displacing the click wheel 211 so as to disengage said toothings from each other, i.e. the teeth of the click wheel 211 are no longer in contact with those of the display wheel 21.

If the click mechanism 210 comprises a return member 212, the torque exerted on the toothing of the click wheel 211 counters the return force exerted by the return member 212 on said click wheel 211. The click wheel 211 is thus immediately brought back into contact with the display wheel 21, in the stop position, following the disengagement of the toothings of the click wheel 211 and of the display wheel 21.

In the example embodiment of the invention shown in the figures, the click wheel 211 thus rolls, like a planet wheel, on the driving wheel 110 as the display wheel 21 rotates, moving back and forth.

Alternatively or additionally, the click wheel 211 can be engaged in a guide track, in a manner similar to the sliding-gear assembly 40, so as to guide the click wheel 211 during its displacement when the sliding-gear assembly 40 is urged in the first direction of rotation. For example, the guide structure can be configured to guide the click wheel 211 rotatably about an axis passing through the centre of the driving wheel set 11 or translatably along a rectilinear trajectory tangential to a circle concentric with the driving wheel set 11.

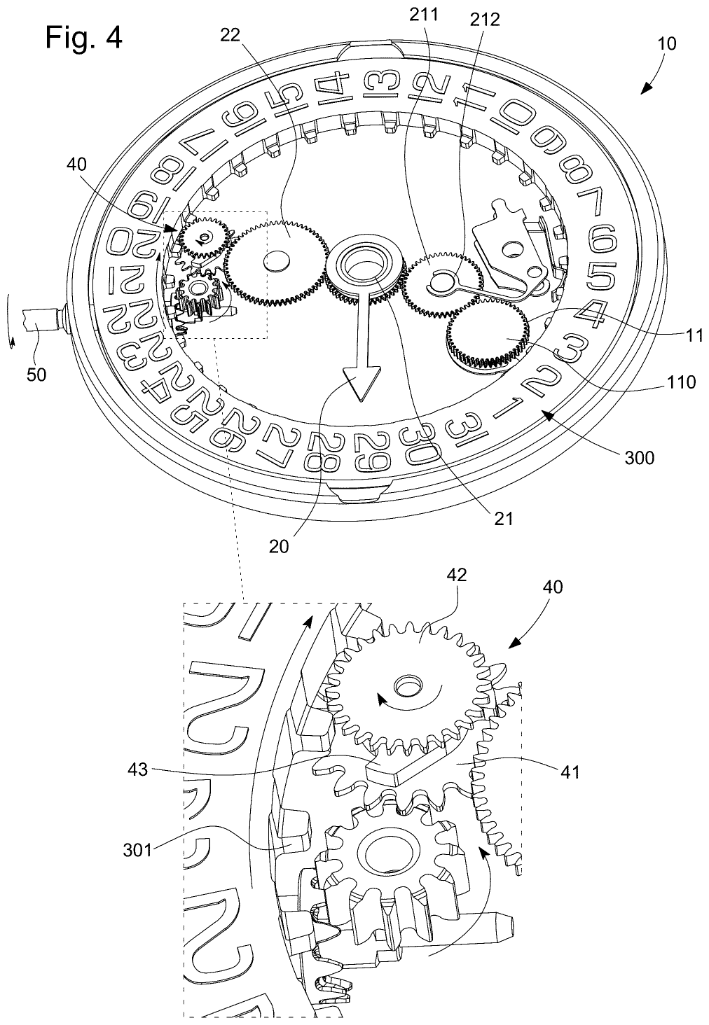

As illustrated in FIG. 4, when it occupies the adjusting position and is urged in a second direction of rotation, the control member 50 is configured to drive the sliding-gear assembly 40 into a second correction position in which the latter is able to modify the position of the second display 30 by means of a second display mechanism 300.

It should be noted that, when in the first position, the sliding-gear assembly 40 is engaged with the display wheel 21, as described above, and is disengaged from the second display mechanism 300, as shown in FIG. 3. Conversely, when in the second position, the sliding-gear assembly 40 is engaged with the second display mechanism 300 and is disengaged from the display wheel 21, as shown in FIG. 4.

The sliding-gear assembly 40 includes a second adjusting wheel 43 by means of which it can be kinematically connected to the second display mechanism 300. This second adjusting wheel 43 consists of a cam including at least one corrector finger-piece, for example three, as shown in the figures. The driving wheel 41 and the first and second adjusting wheels 42 and 43 are arranged coaxially.

In particular, in the preferred example embodiment of the present invention, and as can be seen in the detail view of FIG. 4, the second display mechanism 300 includes a toothing 301 linked to the second display 30, constituted here by a date disc. The corrector finger-piece is able to cooperate with the toothing 301 so as to drive the second display 30 in a sequential rotation during the rotation of said sliding-gear assembly 40 thanks to the indexing by a jumper spring 213 arranged under the return member 212, when the sliding-gear assembly 40 is in the second correction position.

In the preferred example embodiment of the invention, the driving wheel set 11 comprises a driving finger-piece 111 able to cooperate with the toothing 301 of the second display mechanism 300 to drive the second display 30 in a sequential rotation of one step, for each revolution of said driving wheel set 11, as seen in FIG. 1.

This driving finger-piece 111 can include a safety system, as shown in detail in FIG. 2, which is well known to a person skilled in the art and allows said driving finger-piece 111 to retract so as not to transmit any rotational motion to the driving wheel set 11 when the second display 30 is driven by the sliding-gear assembly 40, in order not to upset the time zone display.

More generally, it should be noted that the implementations and embodiments considered above have been described by way of non-limiting examples, and that other alternatives are consequently possible.

1. A horological movement comprising a driving wheel set kinematically linked to a first and to a second display mechanism respectively intended to drive a first and a second display of a time value, a mechanism for adjusting the position of these displays including a sliding-gear assembly and a control member adapted to assume an adjusting position wherein the control member is engaged with the sliding-gear assembly and wherein:
when urged in a first direction of rotation, the control member drives the sliding-gear assembly into a first correction position wherein the sliding-gear assembly is able to cooperate with the first display mechanism so as to modify the position of the first display, and
when urged in a second direction of rotation, the control member drives the sliding-gear assembly into a second correction position wherein the sliding-gear assembly is able to cooperate with the second display mechanism so as to modify the position of the second display,
the first display mechanism including a click mechanism having a click wheel capable of kinematically linking the driving wheel set and a display wheel carrying the first display so as to transmit the rotation of the driving wheel set to the first display, said click wheel being movable in a plane orthogonal to its axis of rotation when the control member is operated to modify the position of the first display, so as to interrupt the kinematic link between the first display mechanism and the driving wheel set.

2. The horological movement according to claim 1, wherein the driving wheel set comprises a driving wheel which lies in the same plane as the click wheel and the display wheel.

3. The horological movement according to claim 2, wherein the click mechanism comprises a return member integral with the click wheel so as to force the click wheel towards a stop position wherein the click wheel is engaged with the driving wheel and with the display wheel.

4. Horological The horological movement according to claim 3, wherein the return member is arranged in the same plane as the driving wheel, the click wheel and the display wheel.

5. The horological movement according to claim 1, wherein, when in the first position, the sliding-gear assembly is engaged with the first display mechanism and disengaged from the second display mechanism, and when in the second position, the sliding-gear assembly is engaged with the second display mechanism and disengaged from the first display mechanism.

6. The horological movement according to claim 1, wherein the sliding-gear assembly comprises the following elements, arranged coaxially:
a driving wheel which can be rotated by the control member,
a first adjusting wheel kinematically connected to the first display mechanism when the control member is in the adjusting position and is urged in the first direction of rotation, and
a second adjusting wheel kinematically connected to the second display mechanism when the control member is in the adjusting position and is urged in the second direction of rotation.

7. The horological movement according to claim 6, wherein the display wheel is formed by a time zone wheel, the first display mechanism comprising a transmission wheel kinematically connecting the time zone wheel and the first adjusting wheel when the control member is in the adjusting position and is urged in the first direction of rotation.

8. The horological movement according to claim 1, wherein the second adjusting wheel of the sliding-gear assembly is formed by a cam comprising at least one corrector finger-piece able to cooperate with a toothing of the second display mechanism integral with the second display so as to drive said second display in sequential rotation during the rotation of said sliding-gear assembly when it occupies the second correction position and when the control member is urged in the second direction of rotation.

9. The horological movement according to claim 1, wherein the driving wheel set comprises a driving finger-piece able to cooperate with the toothing of the second display mechanism to drive the second display in rotation during the rotation of said driving wheel set.

10. The horological movement according to claim 9, wherein the second display is formed by a date disc and is driven in sequential rotation during the rotation of said driving wheel set.

11. The horological movement according to claim 1, wherein the click mechanism comprises a guide structure adapted to movably guide the click wheel when the sliding-gear assembly is urged in the first direction of rotation.

12. The horological movement according to claim 11, wherein the guide structure is configured to guide the click wheel rotatably about an axis passing through the centre of the driving wheel set or translatably along a rectilinear trajectory tangential to a circle concentric with the driving wheel set, when the sliding-gear assembly is urged in the first direction of rotation.
